(19) United States
(12) Patent Application Publication
(10) Pub. No.: US 2012/0326043 A1
(43) Pub. Date: Dec. 27, 2012

(54) NEUTRON DETECTION APPARATUS AND A METHOD OF USING THE SAME

(75) Inventor: Artan Duraj, Seven Hills, OH (US)

(73) Assignee: SAINT-GOBAIN CERAMICS & PLASTICS, INC., Worcester, MA (US)

(21) Appl. No.: 13/532,110

(22) Filed: Jun. 25, 2012

Related U.S. Application Data
(60) Provisional application No. 61/501,476, filed on Jun. 27, 2011.

(51) Int. Cl. G01T 3/06; G01T 3/00

(52) U.S. Cl. 250/362; 250/390.01; 250/361 R; 250/368; 250/367

(57) ABSTRACT

A neutron detection apparatus can include a neutron sensor and a photosensor optically coupled to the neutron sensor. In an embodiment, the photosensor includes a box-and-line photomultiplier, and in another embodiment, the photosensor includes a box-and-grid photomultiplier. The neutron detection apparatus provide unexpectedly better pulse shape analysis, pulse shape discrimination, or both. In a particular embodiment, the neutron may also be configured to detect gamma rays.

### CROSS-REFERENCE TO RELATED APPLICATION

This application claims priority under 35 U.S.C. §119(e) to U.S. Patent Application No. 61/501,476 entitled “Neutron Detection Apparatus and a Method of Using the Same,” by Duraj, filed Jun. 27, 2011, which is assigned to the current assignee hereof and incorporated herein by reference in its entirety.

### FIELD OF THE DISCLOSURE

The present disclosure is directed to neutron detection apparatuses and methods of using such neutron detection apparatuses.

### BACKGROUND

Neutron detection apparatuses are used in a variety of applications. For example, neutron detector apparatuses can be used for applications, such as a medical diagnostic apparatus, a security screening apparatus, military applications, or the like. Further improvement of neutron detection apparatuses is desired.

### BRIEF DESCRIPTION OF THE DRAWINGS

Embodiments are illustrated by way of example and are not limited in the accompanying figures.

FIG. 1 includes a schematic depiction of a neutron detection apparatus in accordance with embodiments described herein.

FIG. 2 includes an illustration of cross-sectional view of a neutron sensor in accordance with a particular embodiment.

FIG. 3 includes a schematic depiction of a box-and-line photomultiplier.

FIG. 4 includes a schematic depiction of a box-and-grid photomultiplier.

FIG. 5 includes an illustration of a perspective view of a neutron detection apparatus and an object near the neutron detection apparatus.

FIG. 6 includes an energy spectrum for pulse shape discrimination using data collected from different neutron detection apparatuses.

FIG. 7 includes an energy spectrum for pulse height analysis using data collected from different neutron detection apparatuses.

FIG. 8 includes energy spectra using data collected from different neutron detection apparatuses.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the scintillation and neutron detection arts.

A neutron detection apparatus can include a neutron sensor and a photosensor. In a particular aspect, the photosensor can be of a type other than a linearly-focused photomultiplier. In a particular embodiment, the photosensor can be a box-and-line or box-and-grid photomultiplier. In another aspect, the neutron detection system can more accurately perform pulse shape discrimination with respect to gamma rays and neutrons. When quantified, the pulse shape discrimination is improved to an unexpectedly large degree. Non-limiting embodiments as described below help to provide a better understanding of the concepts described herein.

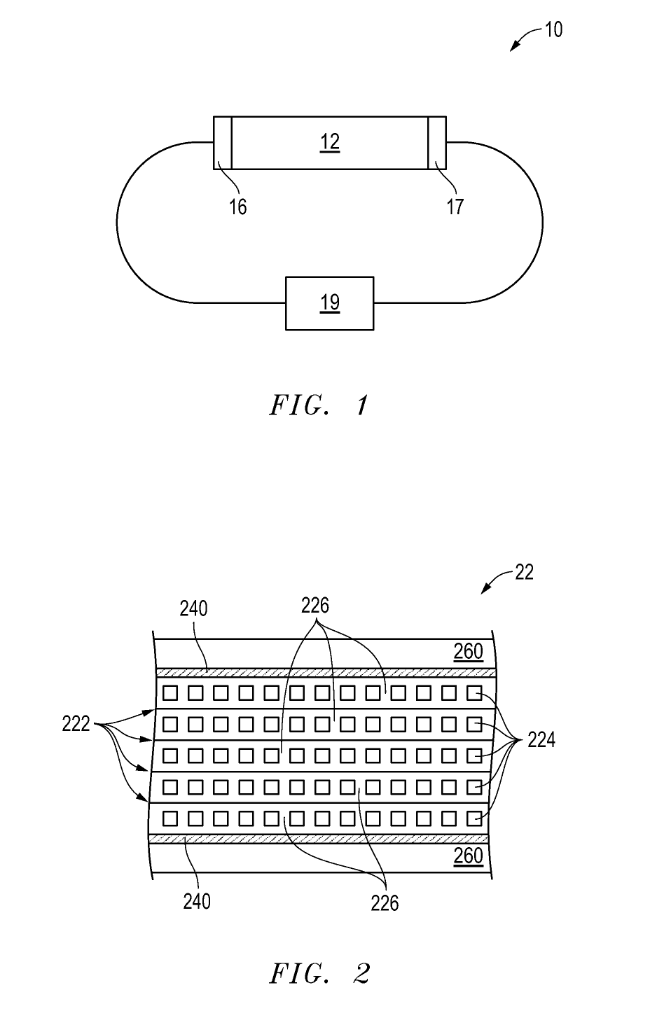

FIG. 1 includes a schematic depiction of an embodiment of a neutron detection apparatus 10. The neutron detection apparatus can be a medical imaging apparatus, a well logging apparatus, a security inspection apparatus, or the like. In a particular embodiment, the neutron detection apparatus 10 is used for neutron detection, and may also be used to detect gamma rays. In the embodiment illustrated in FIG. 1, the neutron detection apparatus 10 includes a neutron sensor 12 and photosensors 16 and 17 that are optically coupled to the neutron sensor 12. In an alternative embodiment (not illustrated), one of the photosensors 16 or 17 may be replaced by a reflector. Only one photosensor may be used with a reflector in place of the photosensor on the other side of the detector. The photosensors 16 and 17 are electrically coupled to an electronics module 19. Each of the neutron sensor 12, photosensors 16 and 17, and electronic module are described in more detail below.

FIG. 2 includes a cross-sectional view of a particular embodiment of a neutron sensor 22, which is a non-limiting embodiment of the neutron sensor 12. The neutron sensor includes layers 222 of a radiation-sensitive material that can emit scintillating light in response to capturing targeted radiation. The neutron sensitive material can include NaI:Tl, CsI:Tl, Bi₄Ge₃O₁₂, LaBr₃:Ce, LaCl₃:Ce, CaF₂:Eu, Gd₂SiO₅:Ce, GdI₃:Ce, Lu₂₋ₓYₓSiO₅, wherein x is in a range of 0 to 2; ZnS:Ag, ZnS:Cu, Y₂SiO₅:Ce, ZnO:Ga, ZnCdS:Cu, Cs₂LiYCl₆:Ce, Cs₂LiYCBr₆:Ce Cs₂LiLaCl₆:Ce, Cs₂LiGdCl₆(Ce), Cs₂LiLaBr₆:Ce, LiF(Ti), LiI(Eu), Li₆Gd(BO₃)₃, or an organic liquid scintillator that includes an organic solvent, such as toluene, xylene, benzene, phenylcyclohexane, triethylbenzene, decalin, phenylxylyl ethane (PXE). In addition, the liquid scintillator material can include a neutron absorber, such as a compound including a neutron responsive element, such as ¹⁰B, ⁶Li, ¹¹³Cd, ¹⁵⁷Gd, or any combination thereof. In a more particular embodiment, the neutron absorber can include ⁶LiF. A scintillator that includes ⁶LiF and a ZnS is commercially available as BC-704™-brand and BC-705™-brand scintillator products from Saint-Gobain Crystals of Hiram, Ohio, USA. When the scintillator includes ⁶LiF and a ZnS, the radiation-sensitive material can emit scintillating light when a thermal neutron or gamma ray is captured by the radiation-sensitive material. Thus, the mere emission of scintillating light from the radiation-sensitive material may not be isolated to a neutron or a gamma ray without a further analysis being made. The radiation-sensitive material can further include an organic binder, wherein the radiation-sensitive material is dispersed within the organic binder. Accordingly, the neutron sensor 12 includes an organic scintillator.

Scintillating light from the layers 222 passes through a clear epoxy 226 or another material that allows a substantial amount of light to be transmitted to and received by optical fibers 224. The optical fibers 224 can transmit scintillating light to one or both of the photosensors 16 and 17 (FIG. 1). In a particular embodiment, the optical fibers 224 can be in the form of a bundle at a location adjacent to one or both of the photosensors 16 and 17. The bundle can have a width of at least approximately 15 mm, at least approximately 25 mm, at least approximately 30 mm, or at least approximately 35 mm. In a more particular embodiment, the bundle can have a width of at least approximately 40 mm. Such widths, particular the larger widths can be significant as the size of the sensing area of the neutron detection apparatus increases. In particular applications where objects are to be analyzed, the ability to couple a wider optical bundle to a photosensor may make inspection of larger objects, such as vehicles (for example, trucks, boats, etc.) more economically feasible.

In an embodiment, the optical fibers 224 may not change the wavelength of the scintillating light. In another embodiment, the optical fibers 224 can change the wavelength of the scintillating light to a longer wavelength. The wavelength shifted scintillating light is an example of a derivative of the scintillating light. Thus, in a particular embodiment, the optical fibers 224 can be wavelength shifting fibers. Such wavelength shifting fibers may be used when one or both of the photosensors 16 and 17 have a higher quantum efficiency for light at a longer wavelength as compared to the scintillating light. In a particular embodiment, the wavelength shifting fibers can shift the scintillating light to blue light or to green light.

A reflector 240 surrounds the combination of the layers 222, the optical fibers 224, and the clear epoxy 226 as illustrated in FIG. 2 to increase the amount of scintillating light received by the optical fibers 224. Further illustrated in FIG. 2 is a neutron moderator 260 that converts fast neutrons to thermal neutrons to increase the likelihood of capture by the phosphorescent material within the layers 222.

After reading this specification, skilled artisans will appreciate that the neutron sensor 22 is merely illustrative of a particular type of neutron sensor 12. Other types and configurations of neutron sensors can be used without departing from the concepts as described herein.

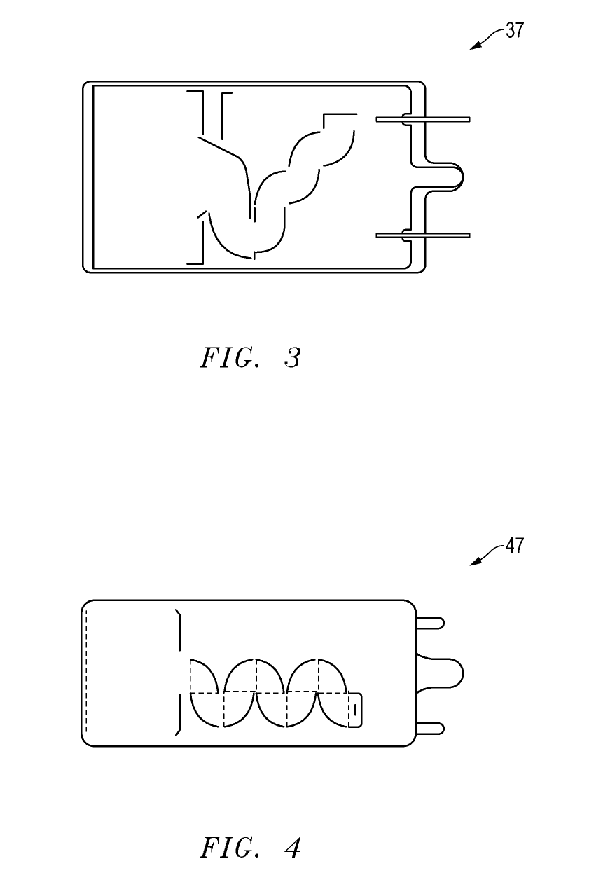

The photosensors 16 and 17 can receive the scintillating light or a derivative thereof, such as the wavelength shifted light, and generate an electronic signal, such as an electronic pulse, in response to the scintillating light or its derivative. Each of the photosensors 16 and 17 can include a box-and-line photomultiplier 37, as illustrated in FIG. 3, or a box-and-grid photomultiplier 47, as illustrated in FIG. 4. In an embodiment, the photosensors 16 and 17 can include the box-and-line photomultipliers 37 or the box-and-grid photomultipliers 47. In another embodiment, one of the photosensors 16 and 17 can include the box-and-line photomultiplier 37, and the other photosensor can include the box-and-grid photomultipliers 47. The significance of the types of photomultipliers will be discussed later in this specification. Although not illustrated in FIG. 1, an amplifier may be used to amplify the electronic signal from the photosensors 16 and 17 before the electronic signal reaches the electronics module 19 or within the electronics module 19.

The electronics module 19 can include an amplifier, a discriminator, an analog-to-digital signal converter, a photon counter, another electronic component, or any combination thereof. The electronics module 19 can be configured to detect particular radiation or detect more than one type of radiation. For example, the electronics module 19 can be configured to detect neutrons or detect neutrons and gamma rays. Analysis may also incorporate one or more signal analysis algorithms in an application-specific integrated circuit (“ASIC”), a field-programmable gate array (“FPGA”), or another similar device. For a neutron detection apparatus that is configured to detect neutrons, a counter can be incremented when a neutron is detected, and for a neutron detection apparatus that is configured to detect gamma rays, a different counter can be incremented when a gamma ray is detected.

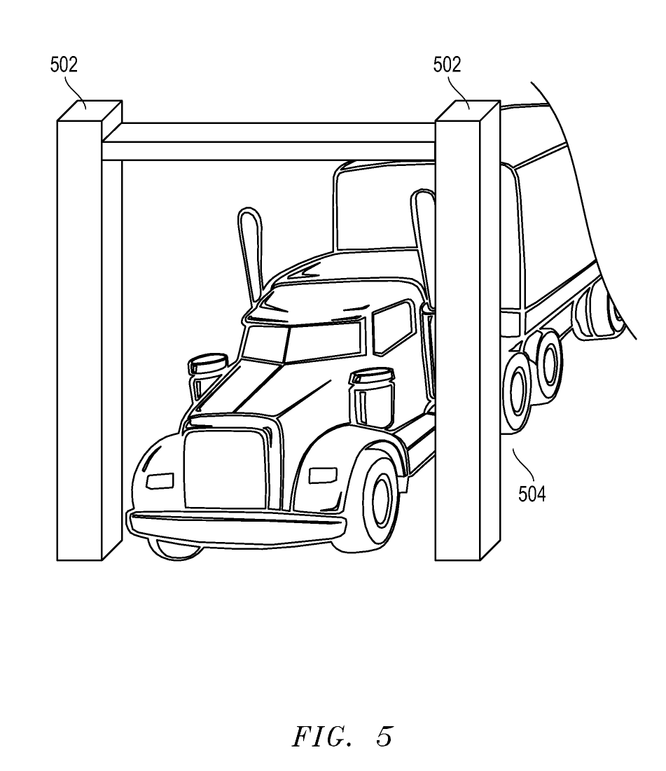

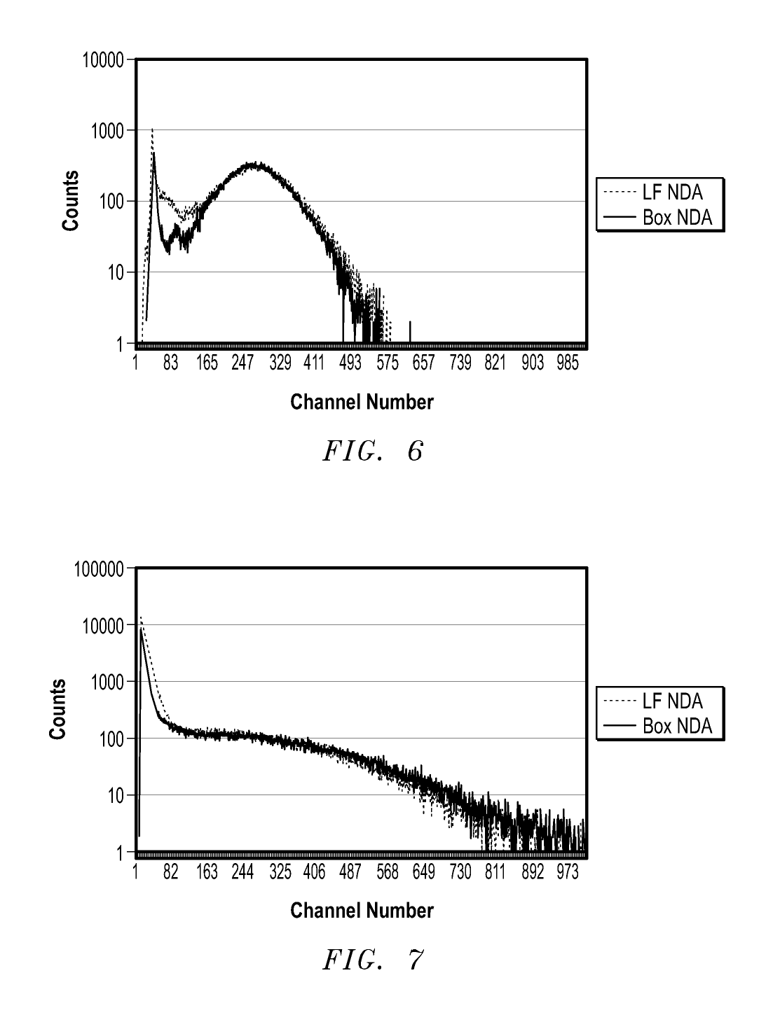

The neutron detection apparatus 10 can be used for a variety of different applications. In a particular embodiment illustrated in FIG. 5, a neutron detection apparatus 502, which is a particular type of the neutron detection apparatus 10, can be used as a security inspection apparatus. The neutron detection apparatus 502 can include one or more neutron sensors and photosensor arrangements (not separately illustrated in FIG. 5) as described herein. The neutron sensor(s) can be of any of the previously described neutron sensors. As illustrated in FIG. 5, the neutron sensor(s) may be located within either or both of the vertical columns, the horizontal cross member, or any combination thereof.

When in use, an object can be placed near or pass through an opening within neutron detection apparatus 502. As illustrated in the embodiment of FIG. 5, the object 504 is a vehicle, and in particular, a truck. The neutron detection apparatus 502 can capture at least part of the targeted radiation emitted by the object (not illustrated) within the vehicle. The neutron sensors can emit scintillating light or wavelength shifted light that is converted to an electronic signal by the photosensors. The electronic signal can be transmitted to an electronics module (not illustrated in FIG. 5) for further analysis.

Conventionally, linearly-focused photomultipliers have been used in neutron detection apparatuses having organic scintillators, which can have significantly faster rise times and decay times of scintillating light as compared to inorganic scintillators. Linearly-focused photomultipliers are characterized by having a significantly faster rise time as compared to box-and-grid photomultipliers and box-and line photomultipliers. In particular, linearly-focused photomultipliers have a rise time of 0.3 ns to 7 ns, box-and-grid photomultipliers have a rise time of 6 ns to 20 ns, and box-and-line photomultipliers have a rise time of 5 ns to 10 ns. Further, a linearly-focused photomultiplier is significantly less expensive than a comparable box-and-line photomultiplier or a box-and grid photomultiplier.

A neutron may be detected using pulse shape discrimination (“PSD”). FIG. 6 includes an exemplary PSD spectrum that is described in more detail later in the Examples section of this specification. A PSD spectrum has an initial peak corresponding to gamma rays. The spectrum has second peak at a higher channel number that corresponds to a neutron. Between the two peaks is a valley. When the valley is shallower, the distinction between the peaks is less pronounced, and as the valley is deeper, the distinction between the peaks is more pronounced. Thus, pulse shape discrimination is better as the valley becomes deeper. The light intensity corresponding to the highest signal for the neutron can divided by the lowest point between the peaks, where such peaks correspond to gamma rays and the neutron. As used herein, such a ratio is referred to as the discrimination ratio, and such a ratio can be used to quantify the pulse shape discrimination of the neutron detection apparatus.

A neutron detection apparatus having a box-and-line or box-and-grid photomultiplier (“Box PMT”) has a discrimination ratio that is unexpected greater than a different neutron detection apparatus that is substantially identical except that a linearly-focused photomultiplier is used instead of a box-and-line or box-and-grid photomultiplier. Such a neutron detection apparatus with the linearly-focused photomultiplier (“LF PMT”) can be referred to as a corresponding neutron detection apparatus. The discrimination ratio for a Box PMT is unexpectedly greater than the discrimination ratio for a LF PMT. In an embodiment, the discrimination ratio for the Box PMT is at least approximately 1.1 times greater, at least approximately 1.5 times greater, or at least approximately 2 times, or at least 2.5 times greater than the discrimination ratio for the LF PMT. In another embodiment, the discrimination ratio for the Box PMT is at least approximately 3 times greater than the discrimination ratio for the LF PMT.

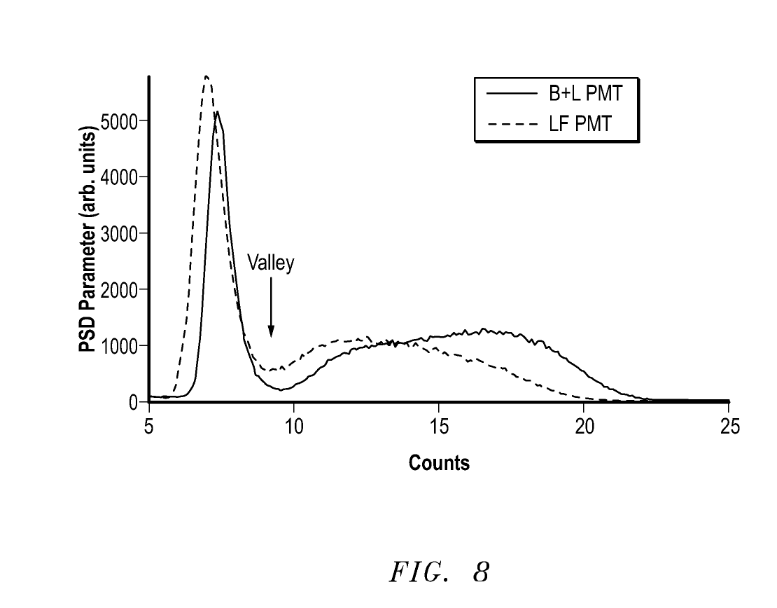

Pulse height analysis (“PHA”) can be performed. FIG. 7 includes an exemplary PHA spectrum that is described in more detail later in the Examples section of this specification. A PHA spectrum has a peak at lower channel numbers that correspond to gamma radiation. The PHA spectrum then flattens out to form a shoulder portion, at which no further gamma radiation is significantly detected. A neutron detection apparatus can have a channel-number filter setting that corresponds to the transition between the peak and the shoulder. In this manner, the neutron detection apparatus may only analyze a spectrum starting at the particular channel number corresponding to the channel-number filter setting. The channel-number filter setting for the Box PMT will be lower than the channel-number filter setting for the LF PMT. The ability to set a lower channel number for the channel-number filter is advantageous, and accordingly, the Box PMT performs better than the LF PMT.

Use of a Box PMT results in an unexpected improvement in neutron efficiency as compared to a LF PMT. From experience, nearly any equipment change to a neutron detection apparatus results in no more than a 2% improvement in efficiency. For example, when changing from a photosensor to a different style of photosensor having similar quantum efficiency curves (that is, quantum efficiency as a function of wavelength of incident radiation), skilled artisans would have expected the improvement in neutron efficiency to be no greater than 2 percent. A Box PMT showed an increase in neutron efficiency at least approximately 4%, approximately 5%, approximately 6%, or approximately 7% or even more greater than a neutron efficiency of a linearly-focused photosensor. In an example described in more detail below, the improvement is 7.1%, which is an unexpectedly good improvement in neutron efficiency.

Conventional beta detectors can have box-and-grid photomultipliers, but beta detectors are not typically configured to discriminate between gamma rays and neutrons. Accordingly, beta detectors are not configured to discriminate between gamma rays and neutrons. Conventional gamma detectors can have organic scintillators, optical transmission sheets, and box-and-line photomultipliers, but, similar to beta detectors, the gamma detectors are not configured to discriminate between gamma rays and neutrons.

Many different aspects and embodiments are possible. Some of those aspects and embodiments are described herein. After reading this specification, skilled artisans will appreciate that those aspects and embodiments are only illustrative and do not limit the scope of the present invention. Additionally, those skilled in the art will understand that some embodiments that include analog circuits can be similarly implemented using digital circuits, and vice versa.

In a first aspect, a neutron detection apparatus can include a neutron sensor, and a photosensor optically coupled to the neutron sensor, wherein the photosensor includes a box-and-line photomultiplier or a box-and-grid photomultiplier.

In an embodiment of the first aspect, the neutron sensor includes a neutron-sensitive scintillation material and optical fibers optically coupled to the photosensor. In another embodiment, the neutron detection apparatus further includes a control module electrically coupled to the photosensor, wherein the control module is configured to perform pulse height analysis or pulse shape discrimination. In a particular embodiment, the control module is configured to increment a counter when a neutron is detected.

In a second aspect, a neutron detection apparatus can include a neutron-sensitive scintillation material and a photosensor optically coupled to the neutron sensor, wherein the photosensor is of a type other than a linearly-focused photomultiplier. The neutron detection apparatus can have a discrimination ratio that is greater than a discrimination ratio for a corresponding neutron detection apparatus including a linearly-focused photomultiplier.

In a third aspect, a method of detecting a neutron can include exposing a neutron to a neutron-sensitive scintillation material to generate scintillating light transmitting the scintillating light or a derivative of the scintillating layer along optical fibers to a photosensor, and generating electrons at the photosensor in response to receiving the scintillating light, wherein the photosensor includes a box-and-line photomultiplier or a box-and-grid photomultiplier.

In an embodiment of the third aspect, the method further includes performing pulse height analysis or pulse shape discrimination in order to determine that the neutron is detected. In a particular embodiment, a discrimination ratio for the neutron detection apparatus is at least approximately 1.1 times, at least approximately 1.5 times, at least approximately 2 times, or at least 2.5 times greater than a discrimination ratio of a corresponding neutron detection apparatus including a linearly-focused photomultiplier. In another particular embodiment, a discrimination ratio for the neutron detection apparatus is at least approximately 3 times greater than a discrimination ratio for a corresponding neutron detection apparatus including a linearly-focused photomultiplier. In a further particular embodiment that performs pulse shape discrimination, the neutron detection apparatus is faster, more accurate, or both at detecting a neutron as compared to a corresponding neutron detection apparatus including a linearly-focused photomultiplier. In another embodiment of the fourth or fifth aspects, the method further includes incrementing a counter when a neutron is detected.

In a particular embodiment of any of the foregoing aspects and embodiments, the optical fibers are in a form of a bundle at a location where the optical fibers are adjacent to the photosensor. In a more particular embodiment, the bundle has a width of at least approximately 15 mm, at least approximately 25 mm, at least approximately 30 mm, or at least approximately 35 mm. In another more particular embodiment, the bundle has a width of at least approximately 40 mm. In another particular embodiment of any of the foregoing aspects and embodiments, the neutron-sensitive scintillation material includes an organic scintillator.

In a further particular embodiment of any of the foregoing aspects and embodiments, the neutron-sensitive scintillation material includes a first compound to produce a secondary particle in response to receiving the neutron, and a second compound to produce the second light in response to receiving the secondary particle. In a more particular embodiment, the first compound includes ⁶Li or ¹⁰B. In another more particular embodiment, the second compound includes ZnS, CaWO₄, Y₂SiO₅, ZnO, CaF₂, or ZnCdS. In still another more particular embodiment, the neutron-sensitive scintillation material is dispersed within an organic binder.

In still a further particular embodiment of any of the foregoing aspects and embodiments, wherein the neutron sensor further includes a neutron moderator to convert a fast neutron to a thermal neutron. In yet a further particular embodiment of any of the foregoing aspects and embodiments, wherein the neutron detection apparatus further includes the optical fibers include a wavelength shifting material that is capable of changing the scintillating light into the derivative of the scintillating light. In a more particular embodiment, the photosensor has a higher quantum efficiency for blue light than the scintillating light. In another more particular embodiment, the photosensor has a higher quantum efficiency for green light than the scintillating light. The neutron detection apparatus or the method of any of the foregoing aspects and embodiments, wherein the photosensor has a neutron efficiency that is at least approximately 4%, approximately 5%, approximately 6%, or approximately 7% greater than a neutron efficiency of a linearly-focused photosensor.

### EXAMPLES

The concepts described herein will be further described in the following examples, which do not limit the scope of the invention described in the claims. The examples below illustrate that a neutron detection apparatus with a box-and-line photomultiplier has improved pulse height analysis and pulse shape discrimination as compared to the neutron detection apparatus with a linearly focused photomultiplier.

An AmBe neutron source is analyzed using a neutron detection apparatus that includes a multi-channel analyzer, an Ortec 460™-brand delay line amplifier from Advanced Measurement Technology, Inc. of Oak Ridge, Tenn., USA, an Ortec 552™-brand pulse-shape analyzer/timing single channel analyzer from Advanced Measurement Technology, Inc. of Oak Ridge, Tenn., USA, and an Ortec 567™-brand time-to-amplitude converter/single channel analyzer from Advanced Measurement Technology, Inc. of Oak Ridge, Tenn., USA. More details on the equipment set up and methodology for the tests are described in “Neutron-Gamma Discrimination with Stilbene and Liquid Scintillators” available from Advanced Measurement Technology, Inc. at http://www.ortec-online.com/Library/index.aspx, which is incorporated herein by reference in its entirety, except as follows. The neutron sensor in this Examples section is ⁶LiF and ZnS:Ag rather than a liquid scintillator, and sample times are longer due to the different scintillator material. Optical fibers are arranged into a bundle having a diameter of approximately 3.9 cm (1.6 inches).

One set of tests use an Electron Tube 9266™-brand photomultiplier, which is a linearly focused photomultiplier tube (“LF PMT”) available from ADIT Electron Tubes of Sweetwater, Tex., USA. Another set of tests use a Hamamatsu R6231™-brand photomultiplier, which is a box-and-line photomultiplier (“B+L PMT”) available from Hamamatsu Corporation, San Jose, Calif. USA.

FIG. 6 includes pulse shape discrimination (“PSD”) spectra for neutron detection apparatuses having the B+L PMT and the LF PMT. The x-axis is a histogram of the time needed to achieve 10% to 90% of an integrated pulse, expressed as a channel number. The neutron detection apparatus having the B+L PMT has a discrimination ratio that is unexpected greater than the neutron detection apparatus when the LF PMT is used instead of the B+L PMT. For the neutron detection apparatus with the LF PMT, the PSD spectrum in FIG. 6 has a second peak that corresponds to a count of 325 and valley that corresponds to a count of 50. Thus, the neutron detection apparatus with the LF PMT has a discrimination ratio of 6.5. For the neutron detection apparatus with the B+L PMT, the PSD spectrum in FIG. 6 has a second peak that corresponds to a count of 354 and valley that corresponds to a count of 18. Thus, the neutron detection apparatus with the B+L PMT has a discrimination ratio of approximately 20. Therefore, the discrimination ratio for the neutron detection apparatus with the B+L PMT has a discrimination ratio that is approximately 3 times greater than the neutron detection apparatus with the LF PMT. The higher discrimination ratio can make the difference between correctly detecting a neutron and not detecting a neutron that is actually present.

FIG. 7 includes pulse height analysis spectra for a neutron detection apparatus with the B+L PMT and the neutron detection apparatus with the LF PMT. As previously described, a neutron detection apparatus can have channel-number filter that set to a channel number corresponding to the transition between the peak and the shoulder. In the neutron detection apparatus with the B+L PMT, the channel-number filter can be set to approximately channel number 80. In the neutron detection apparatus with the LF PMT, the channel-number filter can be set to approximately channel number 100. Accordingly, the neutron detection apparatus with the B+L PMT performs better than the neutron detection apparatus with the LF PMT.

In a further example, the B+L PMT was compared to the LF PMT to determine the increase of neutron efficiency of the B+L PMT over the LF PMT. In order to properly compare the PMT performance, the same neutron detector was tested with the two types of PMTs. For each test, the detector was calibrated according to a specified procedure in order to achieve the same Gamma Absolute Rejection Ratio for neutrons (“GARRn”) for both setups. A ²⁵²Cf (40 ng) neutron source was used in conjunction with a ⁶⁰Co gamma source. The gamma source was placed in such a way as to irradiate the detector at about 10 mR/h. The HV was adjusted for each setup until a GARRn of approximately 1.1. That data is presented in Tables 1 and 2. In the tables, HV is the high voltage for the PMT, N&G is the neutron count rate (counts per second) when the 10mR/h gamma filed is applied, N is the neutron counts per second when only the neutron source is present.

TABLE 1
B + L PMT

| HV (Volts) | N&G (ct/s) | N (ct/s) | GARRn |
|---|---|---|---|
| 810 | 24.4 | 23.9 | 1.02 |
| 830 | 26.5 | 25.4 | 1.04 |
| 850 | 28.6 | 26.9 | 1.06 |
| 875 | 32.7 | 28.0 | 1.17 |

TABLE 2
LF PMT

| HV (volts) | N&G (ct/s) | N (ct/s) | GARRn |
|---|---|---|---|
| 850 | 25.3 | 24.8 | 1.02 |
| 880 | 26.5 | 25.7 | 1.03 |
| 900 | 27.1 | 25.1 | 1.08 |
| 920 | 29.5 | 23.6 | 1.25 |

The high voltage at which the PMT is to operate normally is determined by the GARRn parameter. In this particular test, the HV was adjusted such as the detector will operate neutron efficiency without failing GARRn (maximum of 1.1).

For the B+L PMT, the high voltage at 850 V has GARRn of 1.06, which the closest value at or below 1.10. For the LF PMT, the high voltage at 900 V has a GARRn of 1.08, which is the closest to the value at or below 1.10. Thus, the B+L PMT will normally be operated at 850 V, and the LF PMT will normally be operated at 900 V.

The only differences between the two apparatus are the PMTs and the high voltage used for the PMTs. Under normal operating conditions, the detector with the B+L PMT generates 26.9 neutron counts per second, and the LF PMT generates 25.1 neutron counts per second. The increased efficiency is determined by determining the count rate difference between the PMTs and dividing the difference by the neutron count rate of the LF PMT. Thus, the increased efficiency is (26.9-25.1)/25.1×100%, which is 7.1%. Thus, the efficiency increase is substantially higher than what would have been expected by skilled artisans. A similar improvement or potentially higher improvement should be seen when comparing a B+G PMT to a LF PMT.

FIG. 8 includes a graph showing a PSD spectra collected for a neutron detection apparatuses having the B+L PMT and the LF PMT when operating at 850 V and 900 V, respectively. The x-axis is counts, and the y-axis is a pulse shape discrimination (“PSD”) parameter in arbitrary units. Both spectra include two peaks with a valley between the peaks. The valley between the peaks for the B+L PMT is lower (closer to zero) as compared to the valley between the peaks for the LF PMT. Thus, the spectra demonstrate that the B+L PMT can allow for better gamma ray and neutron discrimination as compared to the LF PMT. In addition the number of counts under the neutron peak is higher yielding in higher neutron efficiency.

Note that not all of the activities described above in the general description or the examples are required, that a portion of a specific activity may not be required, and that one or more further activities may be performed in addition to those described. Still further, the order in which activities are listed is not necessarily the order in which they are performed.

Certain features that are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

1. A neutron detection apparatus comprising:
a neutron sensor; and
a photosensor optically coupled to the neutron sensor, wherein the photosensor comprises a box-and-line photomultiplier, or a box-and-grid photomultiplier.

2. (canceled)

3. The neutron detection apparatus of claim 1, further comprising a control module electrically coupled to the photosensor, wherein:
the neutron sensor comprises:
a neutron-sensitive scintillation material; and
optical fibers optically coupled to the photosensor; and
the control module is configured to perform pulse height analysis or pulse shape discrimination.

4-5. (canceled)

6. A neutron detection apparatus comprising:
a neutron-sensitive scintillation material; and
a photosensor optically coupled to the neutron sensor, wherein the photosensor is of a type other than a linearly-focused photomultiplier,
wherein the neutron detection apparatus has a discrimination ratio that is greater than a discrimination ratio for a corresponding neutron detection apparatus comprising a linearly-focused photomultiplier.

7. A method of detecting a neutron comprising:
exposing a neutron to a neutron-sensitive scintillation material to generate scintillating light;
transmitting the scintillating light or a derivative of the scintillating layer along optical fibers to a photosensor; and
generating electrons at the photosensor in response to receiving the scintillating light, wherein the photosensor comprises a box-and-line photomultiplier or box-and-grid photomultiplier.

8. (canceled)

9. The method of claim 7, further comprising performing pulse height analysis or pulse shape discrimination in order to determine that the neutron is detected, wherein a discrimination ratio for the neutron detection apparatus is at least approximately 1.1 times greater than a discrimination ratio of a corresponding neutron detection apparatus comprising a linearly-focused photomultiplier.

10. (canceled)

11. The method of claim 9, wherein a discrimination ratio for the neutron detection apparatus is at least approximately 3 times greater than a discrimination ratio for a corresponding neutron detection apparatus comprising a linearly-focused photomultiplier.

12. The method of claim 9, wherein, when using pulse shape discrimination, the neutron detection apparatus is faster, more accurate, or both at detecting a neutron as compared to a corresponding neutron detection apparatus comprising a linearly-focused photomultiplier.

13. (canceled)

14. The neutron detection apparatus of claim 3, wherein the optical fibers are in a form of a bundle at a location where the optical fibers are adjacent to the photosensor.

15. The neutron detection apparatus of claim 14, wherein the bundle has a width of at least approximately 15 mm.

16. The neutron detection apparatus of claim 14, wherein the bundle has a width of at least approximately 40 mm.

17. The neutron detection apparatus of claim 3, wherein the neutron-sensitive scintillation material includes an organic scintillator.

18. The neutron detection apparatus of claim 3, wherein the neutron-sensitive scintillation material comprises:
a first compound to produce a secondary particle in response to receiving the neutron; and
a second compound to produce the second light in response to receiving the secondary particle.

19. The neutron detection apparatus of claim 18, wherein the first compound comprises ⁶Li or ¹⁰B.

20. The neutron detection apparatus of claim 18, wherein the second compound includes ZnS, CaWO₄, Y₂SiO₅, ZnO, CaF₂, or ZnCdS.

21-23. (canceled)

24. The neutron detection apparatus of claim 1, further comprising a wavelength shifting material, wherein:
the wavelength shifting material is capable of changing scintillating light into blue light; and
the photosensor has a higher quantum efficiency for blue light than the scintillating light.

25. The neutron detection apparatus of claim 1, further comprising a wavelength shifting material, wherein:
the wavelength shifting material is capable of changing scintillating light into green light; and
the photosensor has a higher quantum efficiency for green light than the scintillating light.

26. The neutron detection apparatus of claim 1, wherein the photosensor has a neutron efficiency that is at least approximately 4% greater than a quantum efficiency of a linearly-focused photosensor.

27. The neutron detection apparatus of claim 3, wherein a discrimination ratio for the neutron detection apparatus is at least approximately 1.1 times greater than a discrimination ratio of a corresponding neutron detection apparatus comprising a linearly-focused photomultiplier.

28. The neutron detection apparatus of claim 3, wherein a discrimination ratio for the neutron detection apparatus is at least approximately 3 times greater than a discrimination ratio for a corresponding neutron detection apparatus comprising a linearly-focused photomultiplier.

29. The neutron detection apparatus of claim 3, wherein, when using pulse shape discrimination, the neutron detection apparatus is faster, more accurate, or both at detecting a neutron as compared to a corresponding neutron detection apparatus comprising a linearly-focused photomultiplier.
